(19) United States
(12) Patent Application Publication
(10) Pub. No.: US 2004/0155809 A1
(43) Pub. Date: Aug. 12, 2004

(54) Infrared remote control command network pass-through

(76) Inventor: Mark Kenneth Eyer, Woodinville, WA (US)

Correspondence Address: Jan Carol Little, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/662,857

(22) Filed: Sep. 15, 2003

Related U.S. Application Data
(60) Provisional application No. 60/445,996, filed on Feb. 6, 2003.

(51) Int. Cl. G08C 19/00; H04L 17/02; G08C 19/12

(52) U.S. Cl. 341/176; 340/825.69

(57) ABSTRACT

Embodiments of the present invention include a method and apparatus for communication of infrared pulse sequences, typically emitted by remote control units associated with audio/video equipment, across a wired or wireless home network. One embodiment of the invention allows one audio/video device to receive a data code sequence from a remote control unit programmed to communicate with another audio/video device and pass on to other audio/video device messages/commands to control the second audio/video device.

### RELATED APPLICATION

The present application claims benefit of priority to U.S. Provisional Application No. 60/445,996 filed Feb. 6, 2003.

### TECHNICAL FIELD

Embodiments of the present invention relate to control systems and, in particular, to optical remote control of audio/video devices.

### BACKGROUND

It is common for many homes to have several audio/video devices located throughout the house. For example, it is common for many homes to have a digital versatile disc (DVD) player in the downstairs family room, a personal video recorder (PVR) such as Tivo® or Replay TV® in the upstairs master bedroom, a surveillance camera for the perimeter of the home, one or more digital televisions (DTV) in the other bedrooms, kitchen, etc. In newer homes, the audio/video devices may be connected to each other in a “home network” in that the audio/video devices are connected via a common communication interface. There are limitations in the current technology, however.

To illustrate one limitation, suppose a homeowner wants to watch a DVD on the digital television in the master bedroom. The homeowner takes the remote control unit for the DVD player to the master bedroom and attempts to remotely operate the DVD player located in the family room. Unfortunately, remote control units designed using infrared technology may require line-of-sight communication with their target device. Thus, to control the DVD player from the master bedroom, the remote control unit for the DVD player must have line-of-sight with the DVD player, which is not possible when the remote control unit is in the master bedroom.

To highlight another limitation, remote control units designed using current known technology are typically programmed to control devices manufactured by their common company but not to control devices manufactured by other companies. This means that if the remote control unit that controls the DVD player were manufactured by one company and the digital television were manufactured by another company, the remote control for the DVD player would be programmed to control the DVD player in the family room, but it could not control the digital television in the master bedroom. Similarly, the remote control for the digital television would be programmed to control the digital television in the master bedroom, but not the DVD in the family bedroom.

### BRIEF DESCRIPTION OF THE DRAWINGS

In the drawings, like reference numbers generally indicate identical, functionally similar, and/or structurally equivalent elements. The drawing in which an element first appears is indicated by the leftmost digit(s) in the reference number, in which:

FIG. 1 is a high-level block diagram of a home network according to an example embodiment of the present invention;

FIG. 2 is a timing diagram showing an example data code sequence according to an embodiment of the present invention;

FIG. 3 illustrates an example representation of the data code sequence depicted in FIG. 2 according to an embodiment of the present invention;

FIG. 4 is a flowchart illustrating an approach to operating a home network according to an embodiment of the present invention;

FIG. 5 is a high-level block diagram of a home network according to an alternative embodiment of the present invention; and

FIG. 6 is a flowchart illustrating an approach to operating a home network according to an alternative embodiment of the present invention.

### DETAILED DESCRIPTION OF THE ILLUSTRATED EMBODIMENTS

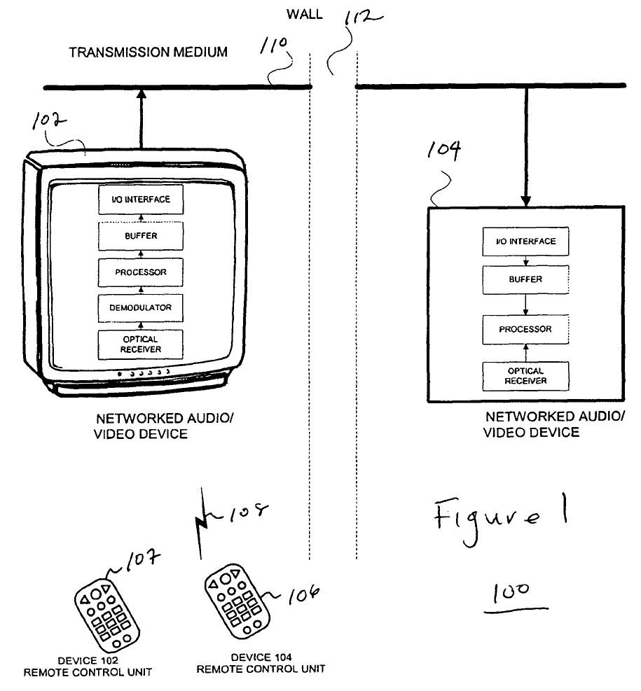

FIG. 1 is high-level schematic diagram of a home network 100 according to an embodiment of the present invention. The home network 100 includes a device 102, a device 104. The home network 100 includes a remote control unit 106 that emits a signal 108, which is recognized by and for the purpose of controlling the device 104. The home network 100 also includes a remote control unit that emits a signal (not shown) recognized by and for the purpose of controlling the device 102. The devices 102 and 104 are coupled to a transmission medium 110. There is a wall 112 located between the devices 102 and 104 resulting in the remote control unit 106 having line-of-sight communication with the device 102 but not with the device 104. The remote control unit 106 is programmed to communicate with the device 104 but not with the device 102.

The example devices 102 and 104 may be audio/video devices. It is understood that an audio/video device refers to any device that transmits and/or receives audio and/or video through wired and/or wireless means. For purposes of illustration, the device 102 is depicted as a display unit. However, embodiments of the present invention are not so limited. Suitable audio/video devices include, but are not limited, to set-top boxes such as those on the premises of cable or satellite service subscribers, televisions such as digital television (DTV) receiver/displays, compact disk (CD) players/recorders, digital versatile disc (DVD) players/recorders, surveillance cameras, personal video recorders such as Tivo®, radios, videocassette recorders/players (VCR), and digital recorders/players.

The example remote control unit 106 is any controller that can emit an optical signal, such as an infrared (IR) signal. The remote control unit 106 has a number of keys that may be depressed to support a number of functions. For example, the remote control unit 106 includes keys which when depressed, allow the user to issue specific commands, such as power on, channel selection, volume selection, skip, rewind, stop, etc.

Although the remote control unit 106 is depicted as a typical handheld remote control unit, embodiments of the present invention are not so limited. For example, the remote control unit 106 may be an IR keyboard or personal digital assistant (PDA).

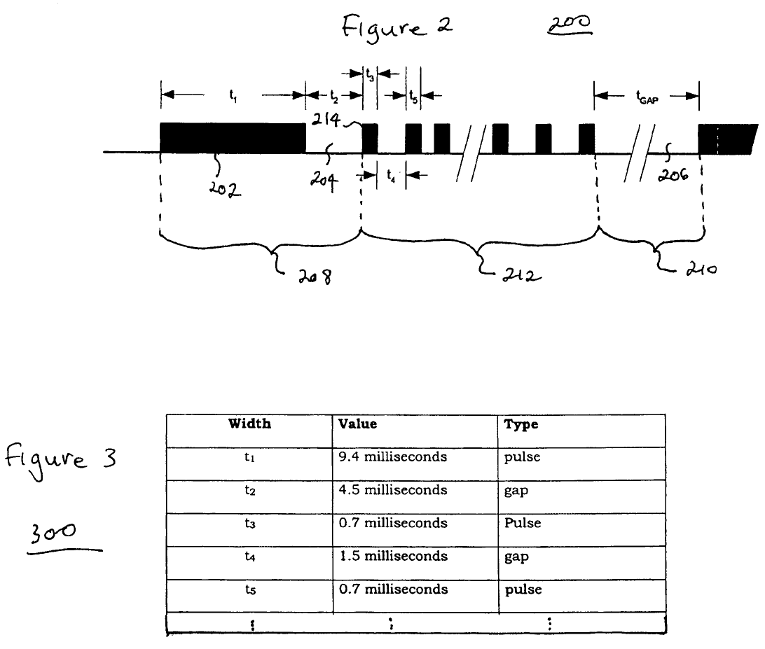

The remote control unit 106 may be programmed such that the signal 108 includes a data code sequence for communicating with the device 104. FIG. 2 is a timing diagram showing an example data code sequence 200 according to an embodiment of the present invention. The example data code sequence 200 includes several pulses having specific pulse widths. Each pulse is separated from the next with gaps of specific widths. For example, a pulse 202 has a width t₁ of six to ten milliseconds and a gap 204 has a width t₂ of four to seven milliseconds. The data code sequence 200 also includes a gap 206 having a width of T_{GAP} milliseconds. In one embodiment, the width t₁ may be in the range of approximately nine to eleven milliseconds and the width t₂ may be in the range of approximately four to six milliseconds.

The combination of the pulse 202 and the gap 204 may represent a “start sequence” 208. When the device 104 is in the line-of-sight of the remote control unit 106 and encounters the example start sequence 208, the device 104 recognizes that particular start sequence 208 and anticipates the beginning of the data code sequence 200.

The gap 206 may represent an “end sequence” 210. In one embodiment, the gap 206 is longer than a predetermined threshold value, thus terminating the example data code sequence 200. When the device 104 is in the line-of-sight of the remote control unit 106 and encounters the example gap 206, the device 104 recognizes that it represents the end of the data code sequence 200.

The data code sequence 200 also may include binary data bits that form a message/command 212 for the device 104. The message/command 212 may be inserted between the start sequence 208 and the end sequence 210. The example binary data bits may start at a pulse 214. In one embodiment, a short pulse followed by a short gap may indicate a logic level “0” and a short pulse followed by a longer gap may indicate a logic level “1.”

It is to be understood that the device 102 does not recognize the data code sequence 200 and does not respond to messages or perform commands included in the data code sequence 200. This is because the communication protocol of the device 102 is different from the communication protocol of the remote control unit 106. Moreover, in contrast to other technologies that operate based on the assumption that devices in a network utilize a common communication protocol, embodiments of the present invention operate based on the assumption that devices in the home network 100 utilize dissimilar communication protocols.

Referring back to FIG. 1, in one embodiment, the signal 108 may be a carrier wave (e.g., amplitude modulated). The example data code sequence 200 may be embodied in the modulation of the carrier wave. In one embodiment, the signal 108 is amplitude modulated at a at frequency approximately thirty-eight kilohertz (38 KHz). The carrier may be modulated at higher or lower rates in other embodiments. For example, the carrier may be modulated at a frequency selected from a range of approximately thirty-eight kilohertz (38 KHz to four hundred fifty-five (455) KHz or more.

Recall from above that there is no line-of-sight communication between the remote control unit 106 and the device 104 and that the remote control unit 106 is not programmed to communicate with the device 102. In embodiments of the present invention, the remote control unit 106 can control the device 104 despite the fact that the remote control unit 106 does not have line-of-sight communication with the device 104 and despite the fact that the remote control unit 106 is not programmed for communicating with the device 102. As a result, when the user presses a key on the remote control unit 106, the device 104 responds appropriately (e.g., plays a DVD, skips a track on a CD, rewinds a tape, etc.).

In one embodiment of the present invention, the device 102 includes an optical receiver 120 that receives the optical signal 108 emitted by the remote control unit 106 and converts the optical signal 108 into a digital serial data stream. Optical receivers suitable for implementing the optical receiver 120 are known and typically include a photodiode appropriately responsive to the incoming infrared signal, an amplifier, a filter responsive to the carrier frequency used, etc.

In one embodiment, the device 102 includes a demodulator 122, which receives the signal 108 and demodulates the signal 108 to recover the data code sequence 200 using known optical signal demodulation techniques. In one embodiment, the demodulator removes a carrier that is amplitude modulated at a frequency of forty kilohertz (KHz) to recover the data code sequence 200.

The device 102 also includes a processorl24, which receives and processes the data code sequence 200 to determine whether it recognizes the data code sequence 200, for example. In one embodiment, the processorl24 determines the details of the data code sequence 200 (e.g., the format of the binary data bits in the message/command 212, etc.). For example, the processor 124 may measure the width of each pulse and each gap in the example data code sequence 200. The measurements are or may be used to generate a representation of the example data code sequence 200. Of course, other techniques of generating a representation of the data code sequence 200 are possible and after reading the description herein, a person of ordinary skill in the relevant art will readily recognize how to implement other embodiments of the present invention using various other processing techniques.

In one embodiment of the present invention, the processor 124 generates a representation of the example data code sequence 200 using known sampling techniques. The processor 124 may buffer the samples from the example data code sequence 200 and provide them in the form of a list, an array, or other format suitable for transmission across the transmission medium 110. The formatted samples are or may be used to generate a representation of the example data code sequence 200.

In an embodiment in which the processor 124 samples the binary bits in the data code sequence 200, the sampling rate may be approximately twenty kHz (thus giving a pulse width measurement accuracy of ±0.05 milliseconds). Of course, other sampling rates are possible and after reading the description herein, a person of ordinary skill in the relevant art will readily recognize how to implement other embodiments of the present invention using various other sampling rates.

FIG. 3 illustrates an example representation 300 of the data code sequence 200 (e.g., a list of collected sample values) according to an embodiment of the present invention. The example representation 300 of the data code sequence 200 lists the contents of the data code sequence 200 including the duration and type for the pulses and gaps in the data code sequence 200.

Referring back to FIG. 1, the device 102 may include a buffer 126, which may store the representation of the example data code sequence 200 to provide a representation of the example data code sequence 200 to an input/output (I/O) interface 128 without noticeable latency or delay. The buffer 126 may be any suitable memory device that can store the representation 300 of the example data code sequence 200. For example, the buffer 126 may be a first-in-first-out (FIFO) buffer or a simple random access memory (RAM).

The I/O interface 128 may receive the representation of the example data code sequence 200 and convert the representation of the example data code sequence 200 into a format compatible with the electrical characteristics of the transmission medium 110. In one embodiment, the I/O interface 128 inserts a representation 300 of the data code sequence 200 in an Internet protocol (IP) packet.

In an alternative embodiment, the transmission medium 110 is an IEEE 1394 Serial Bus as defined by the well-known Institute of Electrical and Electronics Engineers (IEEE) Standard 1394, which is a 1995 IEEE standard for connecting together various digital consumer audio/video products.

In this embodiment, the I/O interface 128 may insert a variable number of the samples of the example data code sequence 200 in a audio-video control Function Control Protocol (A/V C FCP) packet in accordance with protocols for isochronous transfers described by the International Engineering Consortium (IEC) document, titled “IEC 61883 Digital Interface for Consumer Audio/Video Equipment.” Specifically, the I/O interface 128 may include the representation of the example data code sequence 200 in a Function Control Protocol (FCP) wrapper in accordance with IEC 61883-1, which defines among other things a control protocol, data flow management and link management for audiovisual data.

The I/O interface 128 may construct the FCP packet having the representation of the example data code sequence 200and place the FCP packet having the representation of the example data code sequence 200 on the physical transmission medium 110.

The device 104 may include an I/O interface 142 that receives the FCP packets having the representation of the example data code sequence 200 from the transmission medium 110 and converts the FCP packets into data having electrical characteristics compatible with a buffer 144. In addition, the I/O interface 142 may perform some pre-processing functions such as unpacking the FCP packets to recover the representation of the data code sequence 200. The buffer 144 may store the recovered representation of the data code sequence 200 in accordance with the processing time of a processor 146. The storage capacity of the buffer 144 may be sufficient to maintain a continuous transmission of the packets to a processor 146.

The processor 146 may be any microprocessor that is capable of processing the representation of the data code sequence 200. In one embodiment, the processor 146 receives the representation of the data code sequence 200 and responds appropriately (e.g., instructs the device 104 to play a DVD, skip a track on a CD, rewind a tape, etc.).

The device 104 may include an optical receiver 148 that receives the optical signal 108 when the device 104 has line-of-sight with the remote control unit 106. The optical receiver 148 may operate similar to the optical receiver 120. For example, when the device 104 has line-of-sight with the remote control unit 106 the optical receiver 148 receives the optical signal 108 emitted by the remote control unit 106 and converts the optical signal 108 into a digital serial data stream.

In one embodiment, the FCP packet may be “node-addressed” specifically to the device 104. In this embodiment, the device 104 responds as if the device 104 had received the signal 108 having the actual data code sequence 200 via its own optical receiver 148 (e.g., plays a DVD, skips a track on a CD, rewinds a tape, etc.).

In an alternative embodiment, the FCP packet may be “broadcast” to all devices on the transmission medium 110. In this embodiment, the I/O interface 142 may have circuitry and/or logic (programming) to process the FCP packet having the representation of the example data code sequence 200 to determine whether the FCP packet having the representation of the example data code sequence 200 is intended for the device 104. If the FCP packet having the representation of the example data code sequence 200 is intended for the device 104, the device 104 then responds as if the device 104 had received signal 108 having the actual data code sequence 200 via its own optical receiver 148 (e.g., plays a DVD, skips a track on a CD, rewinds a tape, etc.)

The device 104 may then provide an audio/video signal to the device 102 so that the DVD, CD, tape, etc., is displayed or played on the device 102. Such technology is well-known.

Although embodiments of the present invention may be described with respect to the transmission medium 110 being an IEEE 1394 Serial Bus, embodiments of the invention are not so limited. For example, the transmission medium 110 may be any generally known transmission medium, including fiber optic cable, twisted pair, a radio frequency transmission link, or an infra-red link. In one embodiment, the transmission medium 106 is compatible with well-known wired or wireless Ethernet technology.

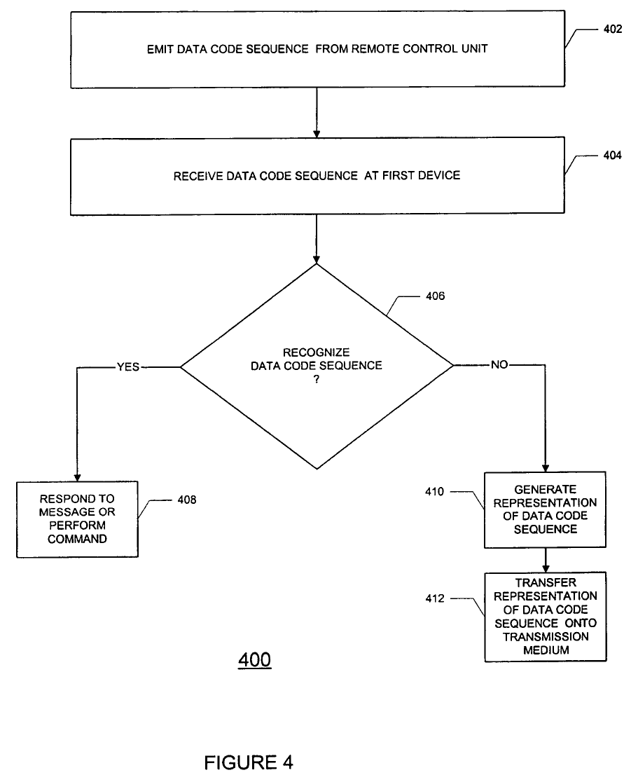

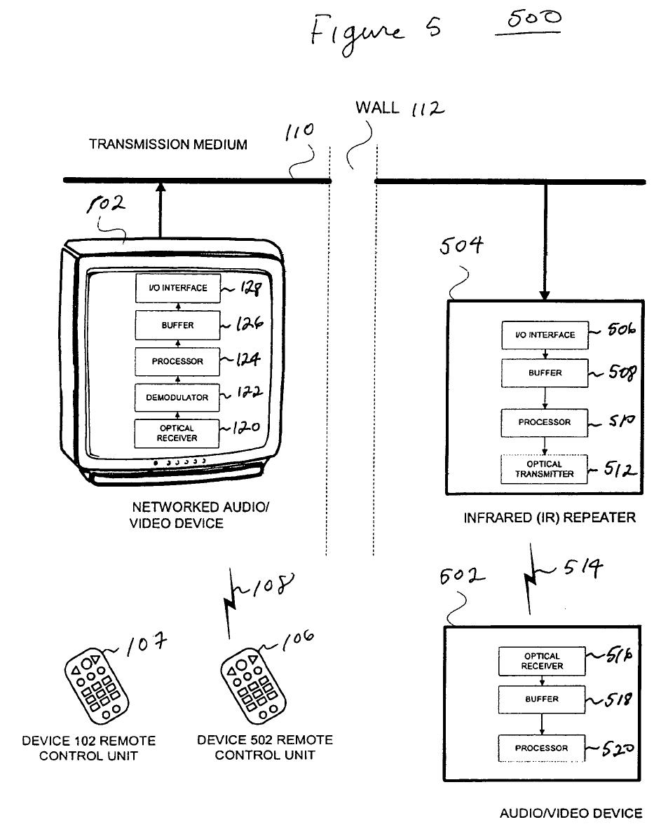

FIG. 4 is a flowchart illustrating a process 400 of operating the example home network 100 according to an embodiment of the present invention. The process 400 will be described as multiple discrete operations performed in turn in a manner that is most helpful in understanding embodiments of the present invention. However, the order in which the operations are described should not be construed to imply that the operations are necessarily order dependent or that they be performed in the order in which they are presented. Of course, the process 400 is only an example process and other processes may be used.

In a block 402, a user pushes a button on a remote control unit. The remote control unit emits an optical signal having a data code sequence recognized by and for controlling a device. In one embodiment, a user pushes a button on the remote control unit 106 and the remote control unit 106 emits the optical signal 108 having the data code sequence 200.

In a block 404, a device receives optical signal having the data code sequence. In one embodiment, the device 102 receives the optical signal 108 having the data code sequence 200.

In a block 406, the device determines whether it recognizes the data code sequence. In one embodiment, the device 102 demodulates the optical signal 108 and processes the data code sequence 200 to determine whether it recognizes the data code sequence 200.

If the device recognizes the data code sequence, control passes to a block 408. In block 408, the device responds to the message and/or performs command in the data code sequence. In embodiments of the present invention, if the device 102 recognizes the data code sequence 200, the device 102 turns “on,” turns “off,” changes channel, changes volume, etc.

If the device does not recognize the data code sequence, control passes to a block 410. In block 410, the device generates a representation of the data code sequence using the measurements (samples) of the data code sequence. In one embodiment, the device 102 does not recognize the data code sequence 200 and thus generates a representation 300 of the data code sequence 200.

In a block 412, the device transfers the representation of the data code sequence to a transmission medium. In one embodiment, the device 102 transfers the representation 300 of the data code sequence 200 to the transmission medium 110 in FCP packets.

FIG. 5 is a high-level block diagram of a home network 500 according to an alternative embodiment of the present invention. The home network 500 includes remote control unit 106 that transmits the optical beam 108 to the device 102 and operates substantially the same as the home network 100 with exceptions noted below.

In one embodiment, the remote control unit 106 transmits the optical signal 108 to the device 102 for controlling a device 502 through an IR repeater 504. The device 102 may perform as described above, i.e., the device 102 samples the data code sequence 200, generates a representation of the data code sequence 200 using the samples of the data code sequence 200, and transmits an FCP packet having the representation of the data code sequence 200 on the transmission medium 110.

The repeater 504 includes an I/O interface 506 that receives the FCP packet from the transmission medium 110 and unpacks the FCP to recover the representation 300 of the data code sequence 200. The repeater 504 includes a buffer 508 that buffers the representation 300 of the data code sequence 200 to ensure a continuous stream to a processor 510.

The processor 510 may translate the representation 300 of the data code sequence 200 back into an infrared signal (e.g., pulses) embodying the data code sequence 200.

The repeater 504 includes an optical transmitter 512 that transmits the data code sequence 200 to the device 502 on an optical signal 514. Optical semiconductors suitable for implementing the optical transmitter 512 are known and typically include a photodiode appropriately responsive to the wavelength of the IR energy, an amplifier, a filter responsive to the carrier frequency in use, etc.

The device 502 receives the signal 514 via an optical receiver 516. The optical receiver 516 may be similar to the optical receiver 120. For example, the optical receiver 516 may receive the signal 514 emitted by the IR repeater 504 and convert the signal 514 into a digital serial data stream. The optical receiver 516 may transmit the serial data stream to a buffer 518.

The buffer 518 may be similar to the bufferl26. For example, the buffer 518 may buffer the data code sequence 200 to maintain a continuous transmission of the example data code sequence 200 to a processor 520 without noticeable interruption.

The signal 514 may be similar to the signal 108 in that when the device 502 receives the signal 514, the device 502 responds as if the device 502 had received the signal 514 having the actual data code sequence 200 via its own optical receiver 516 (e.g., plays a DVD, skips a track on a CD, rewinds a tape, etc.).

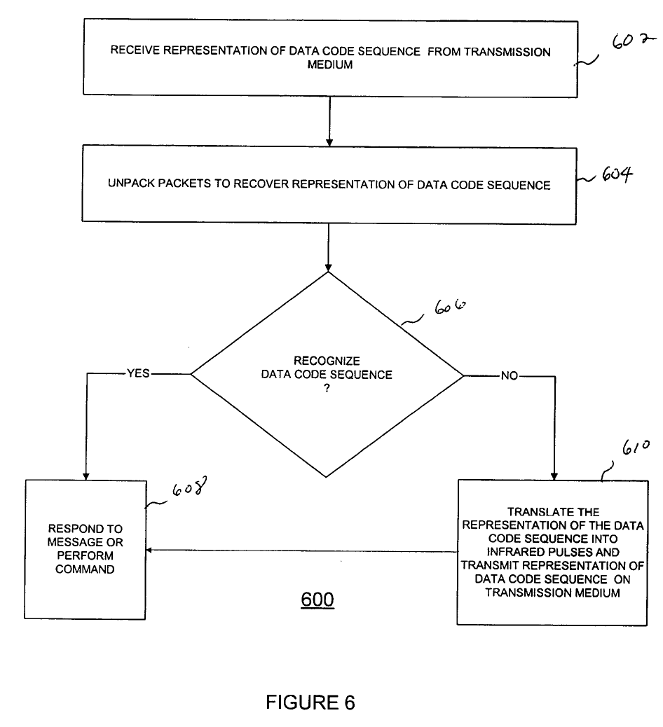

FIG. 6 is a flowchart illustrating a method 600 of operating the home network 100 according an alternative embodiment of the present invention. The process 600 will be described as multiple discrete operations performed in turn in a manner that is most helpful in understanding embodiments of the present invention. However, the order in which the operations are described should not be construed to imply that the operations are necessarily order dependent or that they be performed in the order in which they are presented. Of course, the process 600 is only an example process and other processes may be used.

In a block 602, a device receives a representation of a data code sequence from a transmission medium. In one embodiment, the device 104 receives the representation 300 of the data code sequence 200 from the transmission medium 110. In an alternative embodiment, the device 504 receives the representation 300 of the data code sequence 200 from the transmission medium 110.

In a block 604, the device unpacks the packets (e.g., IP packets, AV/C FCP packets etc.) to recover the representation of the data code sequence. The representation of the data code sequence may or may not be recognized by the device or may or may not be for the purpose of controlling the device. For example, in one embodiment, the device 104 receives the representation 300 of the data code sequence 200 from the transmission medium 110. In this embodiment, the representation 300 of the data code sequence 200 is recognized by the device 104 and is for the purpose of controlling the device 104. In an alternative embodiment, the device 504 receives the representation 300 of the data code sequence 200 from the transmission medium 110. In this embodiment, the representation 300 of the data code sequence 200 is not recognized by the device 504 and is for the purpose of controlling the device 502.

In a block 606, the device determines whether it recognizes the data code sequence. In one embodiment, the device 104 processes the data code sequence 200 to determine whether it recognizes the representation 300 of the data code sequence 200.

If the device 104 recognizes the data code sequence, control passes to a block 608. In block 608, the device 104 responds to the message and/or performs command in the data code sequence. In embodiments of the present invention, if the device 104 recognizes the data code sequence 200, the device 104 turns “on,” turns “off,” changes channel, changes volume, etc.

If the device does not recognize the data code sequence, control passes to a block 610. In block 610, the device translates the representation of the data code sequence back into infrared pulses embodying the data code sequence and transmits the data code sequence to a second device. In one embodiment, the device 504 translates the representation 300 of the data code sequence 200 back into infrared pulses embodying the representation 300 of the data code sequence 200 and transmits the data code sequence to the device 512. Control then passes to block 608 in which the device 504 responds to the message or performs the command in the representation 300 of the data code sequence 200.

Embodiments of the present invention may be implemented using hardware, software, or a combination thereof. In implementations using software, the software may be stored on a machine-accessible medium.

A machine-accessible medium includes any mechanism that provides (i.e., stores and/or transmits) information in a form accessible by a machine (e.g., a computer, network device, personal digital assistant, manufacturing tool, any device with a set of one or more processors, etc.). For example, a machine-accessible medium includes recordable and nonrecordable media (e.g., read only memory [ROM], random access memory [RAM], magnetic disk storage media, optical storage media, flash memory devices, etc.), as well as electrical, optical, acoustic, or other form of propagated signals (e.g., carrier waves, infrared signals, digital signals, etc.).

The above description of illustrated embodiments of the invention is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made in light of the above detailed description.

In the above description, numerous specific details, such as particular processes, materials, devices, and so forth, are presented to provide a thorough understanding of embodiments of the invention. One skilled in the relevant art will recognize, however, that embodiments of the present invention can be practiced without one or more of the specific details, or with other methods, components, etc. In other instances, well-known structures or operations are not shown or described in detail to avoid obscuring the understanding of this description.

Reference throughout this specification to “one embodiment” or “an embodiment” means that a particular feature, structure, process, block, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms used in the following claims should not be construed to limit the invention to the specific embodiments disclosed in the specification. Rather, the scope is to be determined entirely by the following claims, which are to be construed in accordance with established doctrines of claim interpretation.

What is claimed is:

1. A system, comprising:
a first device coupled to a transmission medium;
a second device coupled to the transmission medium; and
a remote control unit for controlling the second device, the remote control unit to transmit a data code sequence, the data code sequence recognized by the second device, the data code sequence for the purpose of controlling the second device,
the first device comprising circuitry to generate a representation of the data code sequence if the data code sequence is not recognized by the first device, and to transfer the representation of the data code sequence to the transmission medium to control the second device.

2. The system of claim 1, wherein the first device is coupled to broadcast the representation of the data code sequence on the transmission medium.

3. The system of claim 1, wherein the remote control unit is coupled to transmit the data code sequence on an infrared (IR) carrier.

4. The system of claim 3, wherein the remote control unit is an infrared (IR) keyboard.

5. The system of claim 4, wherein the remote control unit is personal digital assistant (PDA).

6. The system of claim 1, wherein the representation of the data code sequence is measurement of data code sequence waveform.

7. The system of claim 1, wherein the transmission medium is compatible with a wired or wireless protocol.

8. The system of claim 7, wherein the transmission medium is an IEEE 1394 Serial Bus.

9. The system of claim 7, wherein the transmission medium is compatible with an Ethernet protocol.

10. The system of claim 7, wherein the transmission medium is twisted pair.

11. The system of claim 1, wherein the first device is to include the representation of the data code sequence in an audio-video control (Function Control Protocol (AV/C FCP) packet and to transmit the FCP packet having the representation of the data code sequence to the second device only.

12. The system of claim 1, wherein the first device is to include the representation of the data code sequence in a Function Control Protocol (FCP) packet and broadcast the FCP packet having the representation of the data code sequence on the transmission medium to all devices on the network.

13. The system of claim 1, wherein the first and second devices are audio/video devices.

14. A method, comprising:
receiving at a first device a data code sequence from a remote control unit, the data code sequence recognized by the second device for controlling the second device;
generating a representation of the data code sequence using the if the data code sequence is not recognized by the first device; and
transferring the representation of the data code sequence onto a transmission medium to control the second device.

15. The method of claim 14, further comprising transferring the data code sequence on a modulated carrier.

16. The method of claim 15, further comprising demodulating the modulated carrier.

17. The method of claim 14, further comprising including the representation of the data code sequence in a audio-video control Function Control Protocol (AV/C FCP) packet and broadcasting the FCP packet having the representation of the data code sequence on the transmission medium.

18. The method of claim 14, further comprising including the representation of the data code sequence in a Function Control Protocol (FCP) packet and addressing the FCP packet having the representation of the data code sequence to the second device only.

19. A system, comprising:
a first device coupled to a transmission medium;
a second device coupled to the transmission medium;
a remote control unit for controlling a third device, the remote control unit to transmit a data code sequence, the data code sequence recognized by and for controlling the third device,
the first device comprising circuitry to measure the data code sequence, to generate a representation of the data code sequence from measurements, and to transfer the representation of the data code sequence to the transmission medium,
the second device comprising circuitry to translate the representation of the data code sequence back to the data code sequence and to transfer the data code sequence to the third device to control the third device.

20. The system of claim 19, wherein the remote control unit is an infrared (IR) keyboard.

21. The system of claim 20, wherein the first and third devices are audio/video devices.

22. An apparatus, comprising:
an optical receiver;
a demodulator in communication with the optical receiver, the demodulator to demodulate an optical signal provided by the optical receiver and to recover a data code sequence from the optical signal;
a processor in communication with the demodulator, the processor to sample the data code sequence and to generate a representation of the data code sequence from samples;
a buffer in communication with the processor, the buffer to buffer the representation of the data code sequence to maintain a continuous transmission of the representation of the data code sequence to an input/output (I/O) interface; and
an I/O interface in communication with the buffer, the I/O interface to receive the representation of the data code sequence and to convert the representation of the data code sequence into a format compatible with electrical characteristics of a transmission medium.

23. The apparatus of claim 22, wherein the processor is further to sample binary data bits in a message/command in the data code sequence.

24. The apparatus of claim 22, wherein the demodulator is further to remove an amplitude modulated carrier having a frequency in a range of typically thirty kilohertz (kHz) to sixty kHz, or a narrower range, to recover the data code sequence.

25. The apparatus of claim 24, wherein the processor is further to generate the representation of the data code sequence in the form of a list of the samples.

26. The apparatus of claim 24, wherein the I/O interface is further to insert a representation of the data code sequence in an Internet protocol (IP) packet.
